(19) United States
(12) Patent Application Publication
(10) Pub. No.: US 2005/0136178 A1
(43) Pub. Date: Jun. 23, 2005

(54) Method and apparatus for producing microchannel plate using corrugated mold

(76) Inventors: Dai Gil Lee, Daejeon (KR); Po Jin Kim, Busan (KR); Hak Gu Lee, Daejeon (KR)

Correspondence Address: GRAYBEAL, JACKSON, HALEY LLP, 155 - 108TH AVENUE NE, SUITE 350, BELLEVUE, WA, 98004-5901, US

(21) Appl. No.: 10/741,762

(22) Filed: Dec. 18, 2003

(30) Foreign Application Priority Data
Dec. 18, 2003 (KR) 2002-80954

(51) Int. Cl. B05D 5/12; B05D 3/00

(52) U.S. Cl. 427/58; 427/299; 427/294

(57) ABSTRACT

Disclosed is a method and apparatus for producing a microchannel plate (MCP) using a corrugated mold, characterized in that each of corrugated substrates formed by the corrugated mold is coated with a secondary emitter and then layered, thereby easily producing a large area of the MCP and decreasing production costs of the MCP. The MCP producing method includes placing a first flat substrate on the corrugated mold, vacuum forming the first flat substrate so that both surfaces thereof are corrugated, coating a secondary emitter onto both surfaces of each of the first corrugated substrate and a second flat substrate, and alternately layering a plurality of the first corrugated substrates and a plurality of the second substrates each coated with the secondary emitter, to form microchannels.

### PRIORITY CLAIM

This application claims priority from Korean Patent Application No. 10-2002-0080954 filed 18 Dec. 2002, which is herein incorporated by reference.

### FIELD OF THE INVENTION

The present invention pertains, in general, to a method and apparatus for producing a microchannel plate (MCP) using a corrugated mold. More specifically, the present invention is directed to an MCP producing mold apparatus having a corrugated shape, and a method of producing an MCP using the MCP producing mold apparatus by coating a secondary emitter onto a corrugated substrate and layering a plurality of the corrugated substrates, advantageous in terms of low producing costs and simple producing process.

### BACKGROUND OF THE INVENTION

MCPs are used as a plate-shaped electronic component formed by vertically stacking a plurality of microchannels each functioning to multiply incident electrons. Thus, the MCPs have been mainly employed for electronic devices requiring electron multiplication. The MCPs act as a multiplier in high-gain detectors, such as photomultiplier tubes and image-intensifier tubes, and are applied for various fields, including optical products, for example, night vision systems, laser satellite ranging systems, soft X-ray astronomical telescopes, or planet exploration spectrometers, high-speed oscilloscopes, X-ray image-intensifiers, and the like.

Referring to FIG. 1a, there is shown a structure of a conventional MCP, including 10⁴-10⁷ microchannels 11 stacked vertically. Each microchannel has a diameter of 10-100 μm, and a length amounting to 40-100 times as long as the above diameter. Recently, microchannels having several μm in diameter have been fabricated. The microchannels 11 are fastened by a flange 12, and electrodes 13 are mounted to both ends of the microchannel 11. A voltage of about 1000 V is applied to the electrodes 13 for the acceleration of secondary electrons. A current flowing through the microchannels 11 amounts to several μA.

The electron multiplication of the MCP is performed as follows. When the high energy of initial primary electrons introduced into the microchannels 11 of the MCP are collided with secondary emitters coated onto the walls of the microchannels 11, electrons in the secondary emitters having increased energy are emitted to the microchannels 11. In such a case, the emitted secondary electrons have relatively lower energy, compared to the primary electrons, and are accelerated by electric fields in the microchannels 11 until being collided with the walls of the microchannels 11. Each electron having increased kinetic energy is collided again with the walls of the microchannels 11 to cause the secondary emission.

Since the series of the processes of colliding and emitting the electrons are continuously performed until all the electrons are removed from the microchannels 11, the number of electrons is increased by geometric progression along the longitudinal direction of the microchannels 11. Hence, the secondary electrons, which outnumber the primary electrons 10,000:1 are discharged from an outlet of the microchannels 11.

FIG. 1b shows a process of producing the conventional MCP, in which a tubular glass 17 is combined with a cylindrical core glass 16 to prepare a glass fiber, which is then heated to a pliable state. Through repeated drawing processes, a diameter of the glass fiber is decreased. Such glass fibers are bundled and combined to produce an MCP material. The produced MCP material is cut to have an inclined angle of 0°-10° with respect to a vertical direction, and a ratio of length to diameter of 40-100:1. Through an etching process following the cutting process, microchannels 11 are formed. In such a case, the core glass 16 and the tubular glass 17 have different chemical properties to the etching process. That is, upon the etching process, the core glass 16 is etched and removed, whereas the etched tubular glass 17 remains as it is, to thereby form the microchannels 11. The microchannels 11 are fastened by the flange 12, and the electrodes 13 are mounted to both ends of the microchannel 11. Then, the resistance of the walls of the microchannels 11 is controlled through a reducing process in a hydrogen atmosphere, to complete the production of an MCP.

However, the above method is disadvantageous in terms of high producing costs, and difficulty in the production of large area of MCPs, since the diameter of the glass fiber should be uniformly decreased upon the drawing process and also, excessive enhancement of the temperatures occurs at a central portion of the bundled glass fibers upon the combining process.

To overcome the above problems, U.S. Pat. No. 5,565,729 discloses a method for producing an MCP using a channeled roll, in which a film is passed through the channeled roll to make a channeled film, which is then continuously wound around a cylinder. The wound film is combined and cut to a width equivalent to the length of the microchannel in a radial direction, after which a secondary emitter is coated on an inside of the microchannel, to produce the MCP. However, this method is disadvantageous in terms of high producing costs, since it requires a very accurate coating process of the secondary emitter onto the inside of the microchannel 40-100 times longer than the diameter of the previously formed microchannel.

In addition, a method of producing an MCP using a silicon etching process is disclosed in U.S. Pat. No. 5,997,713. However, since it is difficult to make a silicon wafer having a large area, an MCP having a large area cannot be manufactured by this method.

Further, U.S. Pat. No. 6,045,677 discloses a method of producing an MCP using an anodizing process. According to the above method, anodization of a metal surface results in a thick oxide film containing microchannels ranging from 5 to 500 nm in diameter, which is used to produce the MCP. As such, the closest distance between the two neighboring microchannels amounts to 30 nm. However, this method suffers from high producing costs, due to the requirement of a very accurate coating process as in U.S. Pat. No. 5,565,729.

Therefore, the conventional methods of producing MCPs exhibit only new alternatives concerning the production of the MCPs, and do not propose an inexpensive coating process of a secondary emitter on the walls of the microchannels. Thus, it is difficult to produce a large area MCPs in a low price. Consequently, there is an requirement for the development of producing methods of MCPs in consideration of the secondary emitter-coating process as well as the microchannel-producing process.

### SUMMARY OF THE INVENTION

It is, therefore, an object of the present invention to solve the problems in the prior art and to provide a method for manufacturing a microchannel plate (MCP) using a corrugated mold characterized in that a large area of the MCP coated with a secondary emitter can be produced at decreased costs.

Another object of the present invention is to provide an MCP producing mold apparatus having a corrugated shape, which is suitable for use in the production method of the MCP.

In accordance with a first aspects of the present invention, there is provided a method for manufacturing a microchannel plate (MCP) using a corrugated mold, comprising the steps of: (a) placing a first flat substrate on the corrugated mold; (b) heating the first flat substrate and applying a predetermined pressure over the first flat substrate while a vacuum is applied beneath the first flat substrate to form a first corrugated substrate having both corrugated surfaces at both sides; (c) coating a secondary emitter material onto the corrugated surfaces of the first corrugated substrate; (d) coating the secondary emitter material onto both surfaces of a second flat substrate; and (e) alternately layering a plurality of the first corrugated substrates and a plurality of the second flat substrates each coated with the secondary emitter to form microchannels.

In accordance with a second aspect of the present invension, there is provided a method of producing a microchannel plate (MCP) using a corrugated mold, comprising the steps of: (a) placing a flat substrate on the corrugated mold; (b) heating the flat substrate and applying a predetermined pressure over the flat substrate while a vacuum is applied beneath the flat substrate to form a corrugated substrate having a corrugated surface at a side surface; (c) coating a secondary emitter meterial onto both side surfaces of the corrugated substrate; and (d) layering a plurality of the corrugated substrates each coated with the secondary emitter to form microchannels.

In accordance with a third aspect of the present invention, there is provided a mold apparatus for producing a microchannel plate (MCP), comprising: a plurality of first thin plates and a plurality of second thin plates having a height lower than that of the first thin plates, the first thin plates and the second thin plates being alternately arranged to form a corrugated surface of the mold apparatus, and each of the second thin plates having an air passage so that a vacuum is applied from a plurality of valleys of the corrugated surface of the mold apparatus; and a fastening unit to fasten the first thin plates and the second thin plates.

### BRIEF DESCRIPTION OF THE DRAWINGS

The above and other aspects, features and other advantages of the present invention will be more clearly understood from the following detailed description taken in conjunction with the accompanying drawings, in which:

FIG. 1a is a cross-sectional view of a conventional MCP;

FIG. 1b is a view showing a process of producing the conventional MCP;

FIG. 2 is a schematic view showing a mold apparatus for producing an MCP through a vacuum forming process, according to an embodiment of the present invention;

FIGS. 3a to 3c are views showing mold apparatuses for producing MCPs, according to further embodiments of the present invention;

FIGS. 4a to 4d are views showing a process of producing an MCP, according to a first embodiment of the present invention;

FIGS. 5a to 5d are views showing a process of producing an MCP, according to a second embodiment of the present invention;

FIGS. 6a to 6d are views showing a process of producing an MCP, according to a third embodiment of the present invention; and

FIGS. 7a and 7b are views showing a process of producing an MCP, according to a fourth embodiment of the present invention.

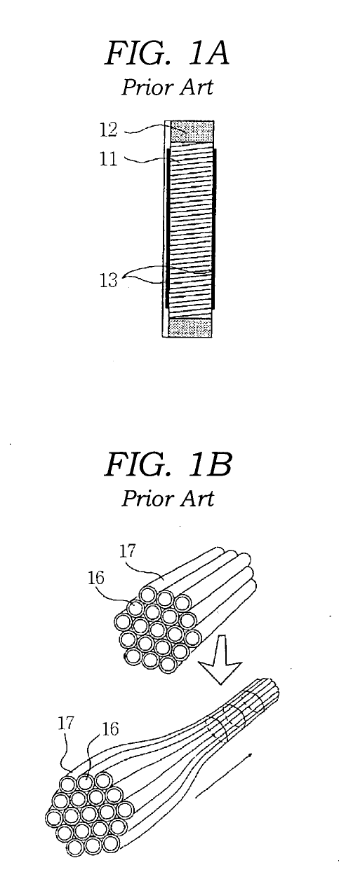

### DETAILED DESCRIPTION OF THE INVENTION

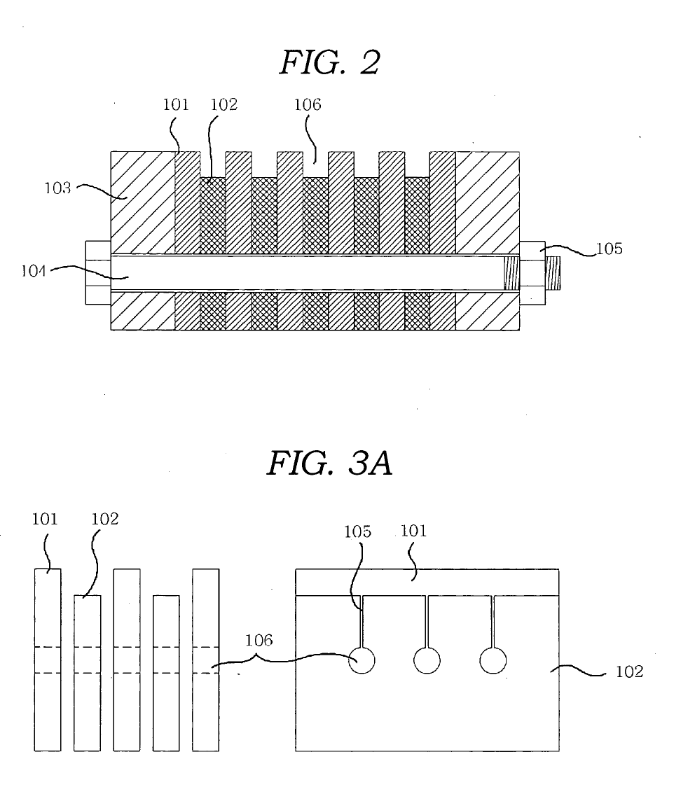

Referring to FIG. 2, there is schematically shown an MCP producing mold apparatus, in accordance with an embodiment of the present invention.

The MCP producing mold apparatus, which is a corrugated mold, includes a plurality of first thin plates 101 and a plurality of second thin plates 102 having a height lower than that of the first thin plates 101, support blocks 103, a bolt 104, and a nut 105. As such, the first thin plates 101 and the second thin plates 102 are alternately arranged, and then fastened by use of a compressible fastening unit, such as the support blocks 103, the bolt 104, and the nut 105, thereby producing the corrugated mold.

The first and second thin plates 101 and 102 are made of various materials, such as stainless steel or copper, and have a thickness of tens to hundreds of micrometers, depending on the sizes of microchannels. The height difference between the first thin plate 101 and the second thin plate 102 amounts to tens to hundreds of micrometers, depending on the sizes of the microchannels. The support blocks 103, the bolt 104 and the nut 105 are used to fasten the alternately arranged thin plates 101 and 102. As such, other fastening units, in addition to the support blocks 103, the bolt 104 and the nut 105, may be used to fasten the first and second thin plates 101 and 102, which is known to those skilled in the art.

Further, in order to make a vacuum be applied from a plurality of valleys 106 of the corrugated mold upon producing the MCP through a vacuum forming process, an air passage is required to eject air from the valleys 106. To form the air passage, proposed various methods may be proposed, such as cutting a part of a second thin plate 102, or using a second thin plate made of a porous material, or roughly treating a portion of a surface of a second thin plate.

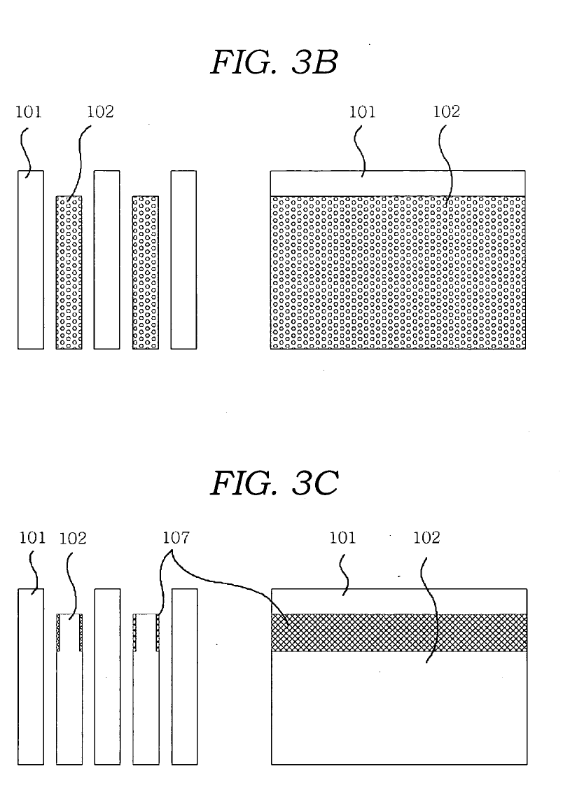

FIG. 3a shows a corrugated mold formed by the method of cutting a part of the second thin plate 102. As shown in FIG. 3a, the second thin plate 102 has fine grooves 105 at an upper part thereof, and vacuum holes 106 perforating through each of the first and second thin plates 101 and 102, in which each fine groove communicates with each vacuum hole. Upon producing the MCP, when the vacuum forming process is performed, air from the valleys 106 of the corrugated mold is evacuated through each groove 105 of the second thin plates 102 and then through each vacuum hole 106.

FIG. 3b shows a corrugated mold formed by the method of using the second thin plates 102, each of which is made of a porous material, for example, a sintered material, including variously shaped powders, such as metal powders or ceramic powders, as well as foams. Upon producing the MCP, when the vacuum forming process is performed, air from the valleys 106 is ejected through a plurality of pores in the porous material of each of the second thin plates 102.

FIG. 3c shows a corrugated mold formed by the method of roughly treating a portion of a surface of the second thin plate 102. Upper parts of the front and rear surfaces of each of the second thin plates 102 are roughly treated to form scratches 107. Upon producing the MCP, when the vacuum forming process is performed, air from the valleys 106 is ejected through the scratches 107 of each of the second thin plates 102.

A better understanding of the present invention may be obtained in light of the following examples for producing the MCP by use of the above corrugated mold which are set forth to illustrate, but are not to be construed to limit the present invention.

### EXAMPLE 1

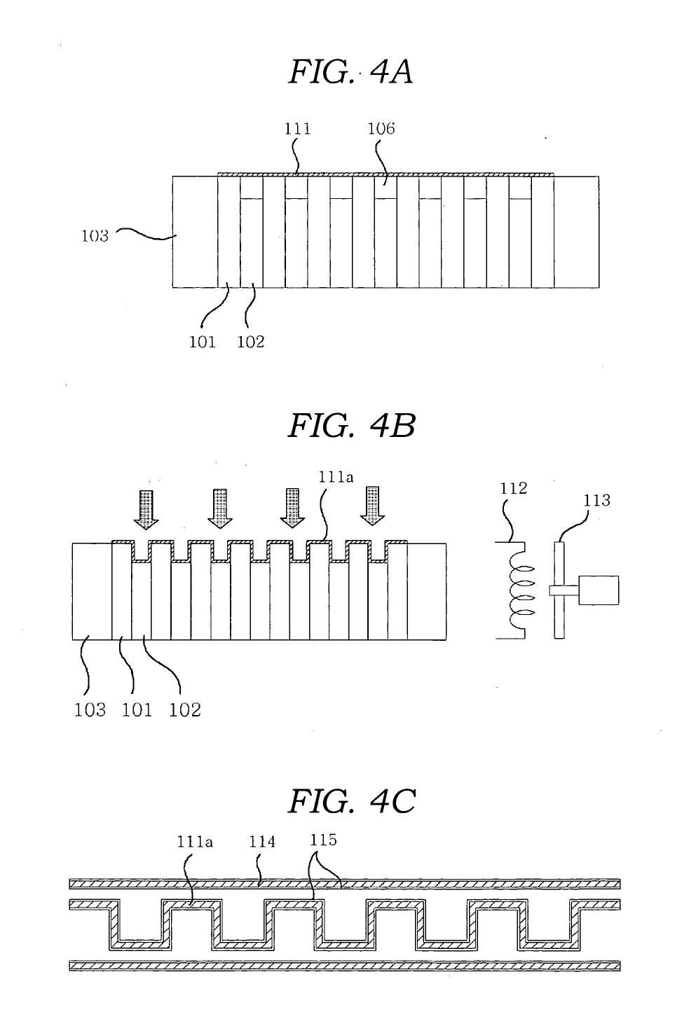

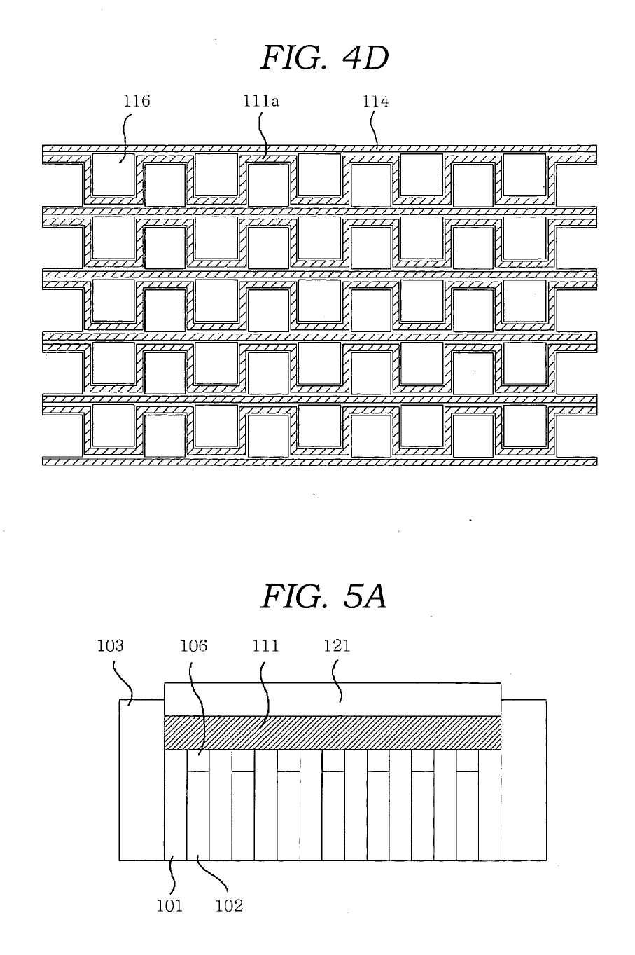

As shown in FIG. 4a, a first substrate 111 was placed on a corrugated mold, prepared by use of a plurality of first thin plates 101 and a plurality of second thin plates 102. As the first substrate 111, a polymer substrate formed of engineering plastics or a glass substrate was used. As shown in FIG. 4b, the first substrate 111 was heated by use of a heater 112 and a fan 113 until it was pliable enough to be vacuumed. While a vacuum was applied from a plurality of valleys 106 of the corrugated mold beneath the first substrate 111, assisted by an air passage in the mold, a high pressure air was applied over the first substrate 111. After a cooling process, a first corrugated substrate 111a having corrugated top and bottom surfaces resulted, to which a predetermined air pressure was applied through the air passage of the corrugated mold, to release the first corrugated substrate 111a from the corrugated mold.

Then, as shown in FIG. 4c, a secondary emitter was coated onto both surfaces of each of the first corrugated substrate 111a and a second flat substrate 114, to prepare a secondary emitter-coated layer 115. As the secondary emitter, SiO₂, MgO, Al₂O₃, ZnO, CaO, SrO, LaO₃, MgF₂, CaF₂, or LiF may be used. The second flat substrate 114 was made of the same material to the first flat substrate 111. Also, the secondary emitter was coated according to a sol-gel process. By means of the sol-gel process, the secondary emitter could be easily coated on the polymer substrate at a temperature as low as the polymer substrate might endure. Alternatively, the secondary emitter could be coated onto the glass substrate even at high temperatures. Thus, the glass substrate was coated with the secondary emitter by more various processes, such as a chemical vapor deposition process, in addition to the sol-gel process, compared to the polymer substrate.

As shown in FIG. 4d, a plurality of the first corrugated substrates 111a and a plurality of the second flat substrates 114 were alternately layered one on top of another, each of which was coated with the secondary emitter. Then, using a predetermined curing cycle, the secondary emitter was cured. Thereby, the alternately layered substrates 111a and 114 were combined together, to produce an MCP material having a plurality of microchannels 116 each coated with the secondary emitter. Thusly produced MCP material was cut to the lengths of desirable microchannels 116. The lengths were 40-100 times the diameter of the microchannel 116. As such, a cutting process was performed in the state of inclining the layered substrates 111a and 114 at a predetermined angle. Thereby, the angled microchannels 116 were formed to easily emit secondary electrons.

Meanwhile, electric resistance on the surface of the secondary emitter-coated layer 115 should be controlled. When a plurality of secondary electrons are emitted upon electron multiplication of the microchannels 116, electrons on the secondary emitter-coated layer 115 can be exhausted. To repeat electron-multiplying processes, therefore, electrons should be supplied to the surface of the secondary emitter-coated layer 115. Such electron-feeding process should be performed in a period between the electron-multiplying process and the next electron-multiplying process. If the surface of the secondary emitter-coated layer 115 was controlled to have proper electric resistance values, electrons could be efficiently supplied. For this, lead oxide (PbO) may be added to the secondary emitter and reduced in a hydrogen (H₂) atmosphere upon a resistance-controlling process so that resistance can be controlled based on a reduced amount of PbO.

After the secondary emitter-coated layer 115 is controlled in electric resistance, both cut surfaces of the MCP are mounted with electrodes, to complete the production of a desired MCP.

### EXAMPLE 2

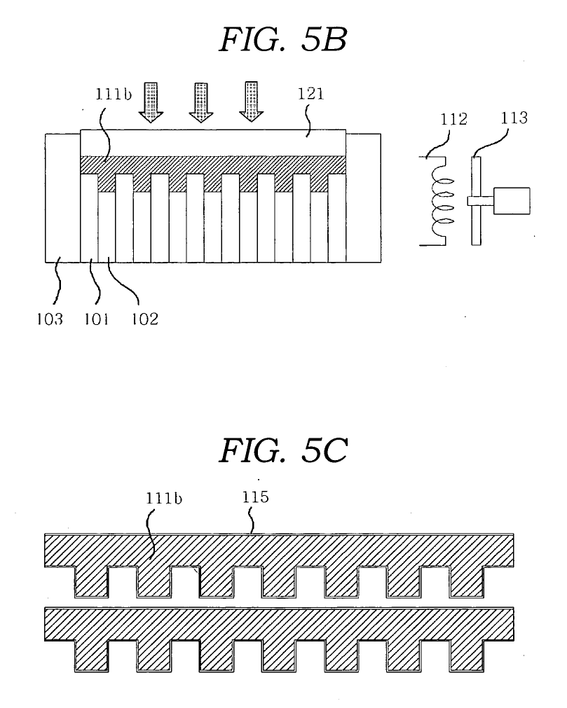

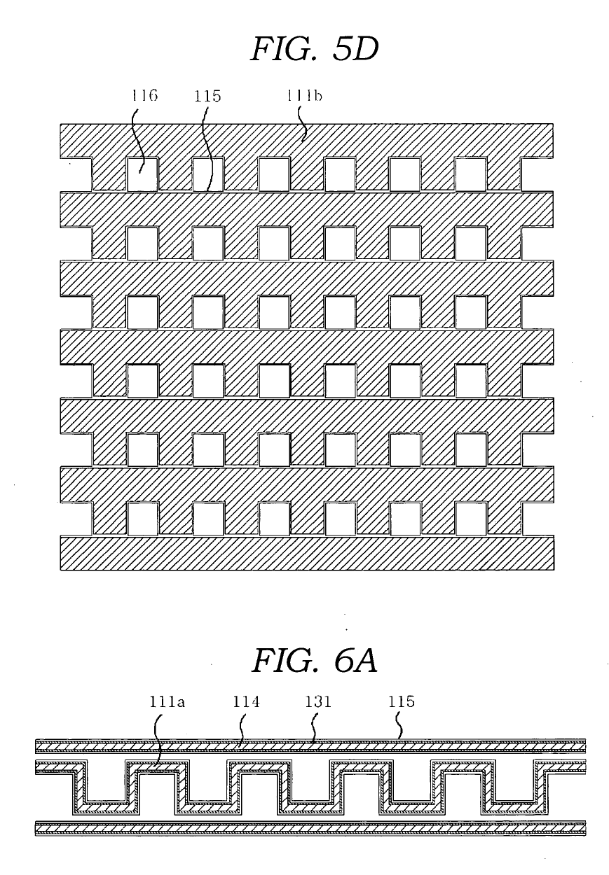

As shown in FIG. 5a, a substrate 111 was placed on a corrugated mold and a flat substrate 121 was placed on the substrate 111. As the substrate 111, a polymer substrate formed of engineering plastics or a glass substrate was used. As shown in FIG. 5b, the substrate 111 was heated by use of a heater 112 and a fan 113. Then, while a vacuum was applied from the valleys 106 of the corrugated mold beneath the substrate 111, assisted by the air passage in the mold, a pneumatic or hydraulic pressure was applied over the flat substrate 121. Thereby, the heated substrate 111 was drawn down into the valleys 106 of the corrugated mold. After a cooling process, a corrugated substrate 111b having a corrugated bottom surface resulted, to which a predetermined air pressure was applied through the air passage, to release the corrugated substrate 111b from the corrugated mold.

As shown in FIG. 5c, a secondary emitter was coated onto the corrugated substrate 111b, to prepare a secondary emitter-coated layer 115. As the secondary emitter, SiO₂, MgO, Al₂O₃, ZnO, CaO, SrO, LaO₃, MgF₂, CaF₂, or LiF may be used.

As shown in FIG. 5d, a plurality of the corrugated substrates 111b each of which coated with the secondary emitter were layered one on top of another. Then, using a predetermined curing cycle, the secondary emitter was cured. The layered substrates 111b were combined together, to produce an MCP material having a plurality of microchannels 116 each coated with the secondary emitter. In the present example, the corrugated substrate 111b had any one corrugated surface, different from both corrugated surfaces of the first corrugated substrate 111a of Example 1. Hence, there was required no alternately layering process by use of a second flat substrate. Thusly produced MCP material was cut to the lengths of desirable microchannels 116. The lengths were 40-100 times the diameter of the microchannel 116. As such, a cutting process was performed in the state of inclining the layered substrates 111b at a predetermined angle.

The secondary emitter-coated layer 115 was controlled in electric resistance, after which both cut surfaces of the MCP were mounted with electrode, to complete the production of a desired MCP.

### EXAMPLE 3

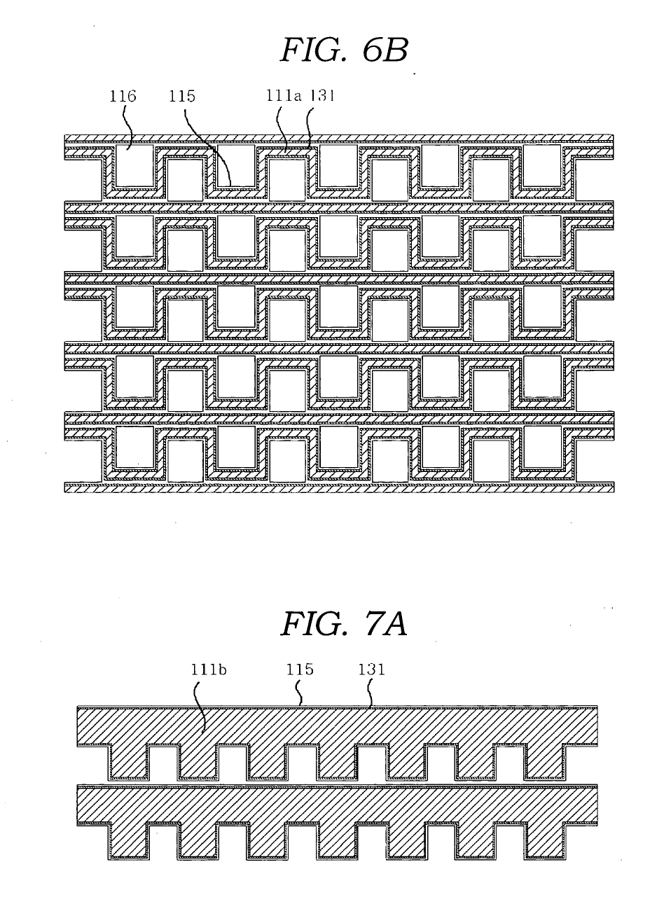

Instead of controlling electric resistance of the secondary emitter-coated layer 115 as in Example 1, an electroconductive layer 131 was positioned below the secondary emitter-coated layer 115, thereby feeding electrons to the secondary emitter-coated layer 115. Therefore, as shown in FIG. 6a, a first corrugated substrate 111a and a second flat substrate 114 prepared in the same manner as in Example 1 were coated with an electroconductive material to prepare the electroconductive layer 131. Then, a secondary emitter was coated on the electroconductive layer 131, thereby giving a secondary emitter-coated layer 115.

As such, as the electroconductive material, use was taken of conductive materials, such as metals or ITO (indium tin oxide). In addition, as the secondary emitter, SiO₂, MgO, Al₂O₃, ZnO, CaO, SrO, LaO₃, MgF₂, CaF₂, or LiF was used.

As shown in FIG. 6b, a plurality of the first corrugated substrates 111a and a plurality of the second flat substrates 114 were alternately layered one on top of another, each of which was coated with the electroconductive material and the secondary emitter. Then, using a predetermined curing cycle, the secondary emitter was cured. The layered substrates 111a and 114 were combined together, to produce an MCP material having a plurality of microchannels 116. Thusly produced MCP material was cut to the lengths of desirable microchannels 116. The lengths were 40-100 times the diameter of the microchannel 116. As such, a cutting process was performed in the state of inclining the layered substrates 111a and 114 at a predetermined angle. Both cut surfaces of the MCP material were mounted with electrodes, to complete the production of a desired MCP.

### EXAMPLE 4

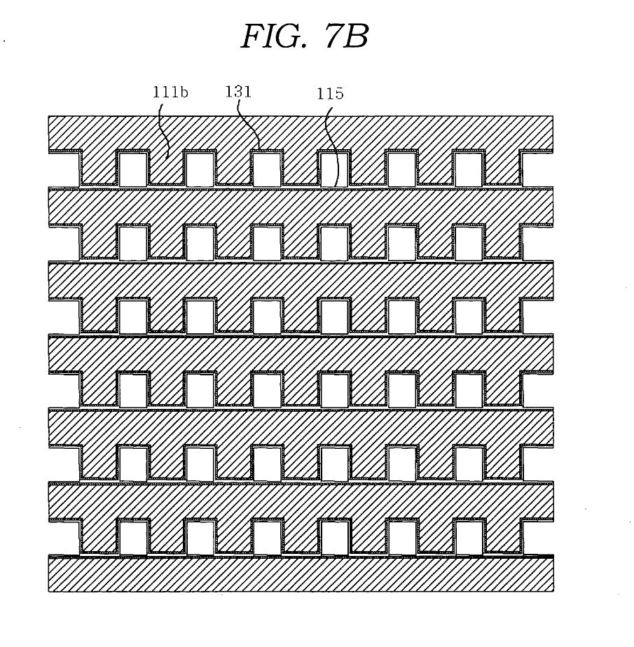

Instead of controlling electric resistance of the secondary emitter-coated layer 115 as in Example 2, an electroconductive layer 131 was positioned below the secondary emitter-coated layer 115, thereby feeding electrons to the secondary emitter-coated layer 115. As shown in FIG. 7a, a corrugated substrate 111b prepared in the same manner as in Example 2 was coated with an electroconductive material, to form the electroconductive layer 131 on the corrugated substrate 111b. Thereafter, the secondary emitter was coated on the electroconductive layer 131 to prepare the secondary emitter-coated layer 115.

As such, as the electroconductive material, use was taken of conductive materials, such as metals or ITO (Indium Tin Oxide). In addition, as the secondary emitter, SiO₂, MgO, Al₂O₃, ZnO, CaO, SrO, LaO₃, MgF₂, CaF₂, or LiF was used.

As shown in FIG. 7b, a plurality of the corrugated substrates 111b each coated with the electroconductive material and the secondary emitter were layered one on top of another. Thereafter, using a predetermined curing cycle, the secondary emitter was cured. The layered substrates 111b were combined together, to produce an MCP material having a plurality of microchannels 116. Thusly produced MCP material was cut to the lengths of desirable microchannels 116. The lengths were 40-100 times the diameter of the microchannel 116. As such, a cutting process was performed in the state of inclining the layered substrates 111b at a predetermined angle. Both cut surfaces of the MCP were mounted with electrodes, to complete the production of a desired MCP.

As described above, the present invention provides a method and apparatus for producing an MCP using a corrugated mold, characterized in that a coating material including a secondary emitter is coated on a corrugated substrate, after which a plurality of the corrugated substrates are layered, whereby a large area of the MCP is easily produced, and the producing costs of MCP is decreased.

The present invention has been described in an illustrative manner of the producing method of an MCP using a corrugated mold, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

1. A method for manufacturing a microchannel plate (MCP) using a corrugated mold, comprising the steps of:
(a) placing a first flat substrate on the corrugated mold;
(b) heating the first flat substrate and applying a predetermined pressure over the first flat substrate while a vacuum is applied beneath the first flat substrate to form a first corrugated substrate having both corrugated surfaces at both sides;
(c) coating a secondary emitter material onto the corrugated surfaces of the first corrugated substrate;
(d) coating the secondary emitter material onto both surfaces of a second flat substrate; and
(e) alternately layering a plurality of the first corrugated substrates and a plurality of the second flat substrates each coated with the secondary emitter to form microchannels.

2. The method according to claim 1, further comprising a step of adding the secondary emitter material with lead oxide (PbO), which is then reduced in a hydrogen (H₂) atmosphere so that resistance of the secondary emitter material is controlled based on a reduced amount of lead oxide.

3. The method according to claim 1, further comprising the step of coating an electroconductive material onto both surfaces of the first corrugated substrate and the second flat substrate before coating the secondary emitter material onto the first corrugated substrate and the second flat substrate.

4. The method according to claim 1, further comprising the step of cutting the microchannels to have a predetermined length with being inclined at a predetermined angle.

5. The method according to claim 1, wherein the secondary emitter material is any one selected from the group consisting of SiO₂, MgO, Al₂O₃, ZnO, CaO, SrO, LaO₃, MgF₂, CaF₂, and LiF.

6. A method of producing a microchannel plate (MCP) using a corrugated mold, comprising the steps of:
(a) placing a flat substrate on the corrugated mold;
(b) heating the flat substrate and applying a predetermined pressure over the flat substrate while a vacuum is applied beneath the flat substrate to form a corrugated substrate having a corrugated surface at a side surface;
(c) coating a secondary emitter meterial onto both side surfaces of the corrugated substrate; and
(d) layering a plurality of the corrugated substrates each coated with the secondary emitter to form microchannels.

7. The method according to claim 6, further comprising the step of adding the secondary emitter material with lead oxide (PbO), which is then reduced in a hydrogen (H₂) atmosphere so that resistance of the secondary emitter material is controlled based on a reduced amount of lead oxide.

8. The method according to claim 6, further comprising the step of coating an electroconductive material onto both surfaces of the corrugated substrate before coating the secondary emitter material onto the side surfaces of the corrugated substrate.

9. The method according to claim 6, further comprising the step of cutting layered substrates to have a predetermined length with being inclined at a predetermined angle.

10. The method according to claim 6, wherein the secondary emitter material is any one selected from the group consisting of SiO₂, MgO, Al₂O₃, ZnO, CaO, SrO, LaO₃, MgF₂, CaF₂, and LiF.

11. A mold apparatus for producing a microchannel plate (MCP), comprising:
a plurality of first thin plates and a plurality of second thin plates having a height lower than that of the first thin plates, the first thin plates and the second thin plates being alternately arranged to form a corrugated surface of the mold apparatus, and each of the second thin plates having an air passage so that a vacuum is applied from a plurality of valleys of the corrugated surface of the mold apparatus; and
a fastening unit to fasten the first thin plates and the second thin plates.

12. The mold according to claim 11, wherein each of the second thin plates is made of a porous material to form pores acting as the air passage.

13. The mold according to claim 11, wherein each of the second thin plates has a roughly treated surface portion at a junction with the first thin plate to form the air passage.

14. The mold according to claim 11, wherein a hole perforating through each of the first thin plates and the second thin plates a good formed on each of the second thin plate, each groove communicating with the hole, whereby the groove and the hole cooperates with each other to provide the air passage.

15. The mold according to claim 11, wherein the fastening unit comprises support blocks attached to both end surfaces of the alternatively arranged first thin plates and second thin plates, a bolt perforating the alternately arranged first thin plates and second thin plates and the support blocks, and a nut tightened to the bolt.
